(19) United States
(12) Patent Application Publication
(10) Pub. No.: US 2009/0165605 A1
(43) Pub. Date: Jul. 2, 2009

(54) Screwdriver with torque-enhancing sidewall edges

(76) Inventor: Richard J. Macor, Hunterdon County, NJ (US)

Correspondence Address: Richard J. Macor;Proprietary Technologies, Inc., 26 Alpaugh Drive, Asbury, NJ, 08802-1213, US

(21) Appl. No.: 12/283,591

(22) Filed: Sep. 12, 2008

Related U.S. Application Data
(63) Continuation-in-part of application No. 12/154,370, filed on May 22, 2008.
Application No. 12/154,370 is a continuation-in-part of application No. 29/294,259, filed on Dec. 31, 2007, now Pat. No. D583642.

(51) Int. Cl. B25B 15/00

(52) U.S. Cl. 81/436

(57) ABSTRACT

An engaging portion of a screwdriver formed for engagement with a work-piece such as a screw, is described. The engaging portion has an engaging tip, a front face, a rear face and opposing side walls. Each side wall has a front groove and a rear groove. Each groove has a wide region and a narrow region with the narrow region located closer to the tip than the wide region so as to create a torque-enhancing side wall edge.

### REFERENCES TO RELATED APPLICATIONS

This application relates to, and is a continuation-in-part of co-pending U.S. patent application Ser. No. 12/154,370 filed on May 22, 2008 entitled ENGAGING PORTION OF A SCREWDRIVER; which is a continuation-in-part of co-pending U.S. patent application Ser. No. 29/294,259 filed on Dec. 31, 2007 entitled SCREWDRIVER BLADE TIP, all of which have been filed by the inventor herein.

### FIELD OF THE INVENTION

The present invention relates to hand tools, particularly screwdrivers, and more particularly screwdrivers referred to in the industry as slotted type.

### BACKGROUND OF THE INVENTION

Screwdrivers have been around for more than a hundred years. The slotted type screwdriver, which is the only type addressed herein, generally has a fixed blade formed to fit within an elongated slot of a work-piece such as a screw etc., to turn the work-piece. When using a slotted type screwdriver, users often encounter engagement failures, whereas, the screwdriver tip slips out of the slot of the work-piece under torque loading. Engagement failures often result in damage to the work-piece, damage to the screwdriver, and sometimes user injury. The engaging portion of a typical, prior art slotted screwdriver often has a profile tapering outwardly from its tip to enhance strength, however, this outward taper tends to promote cam-out and disengagement with a work-piece such as a screw. “Cam-out” is referred to herein as the disengagement of the engaging portion of a screwdriver with a work-piece such as a screw, resulting from the outwardly tapered engaging edges of the screwdriver engaging with the walls of a slot having a lesser taper (or no taper) thereby urging the engaging portion of the screwdriver out of the slot of the work-piece under torque. Alternatively, if the engaging portion of a screwdriver has a profile that tapers inwardly from the tip this may reduce cam-out and engagement failures, but strength is compromised. In fact, if heavy torque is applied to the engaging portion of a screwdriver with a profile tapering inwardly from its tip, this can result in permanent deformation of the screwdriver blade and tip.

Screwdriver engagement designs have come about including the use of micro-grooves placed across the screwdriver face at the tip to enhance the coefficient of friction between the screwdriver tip and work-piece. These micro grooves slightly improve engagement, however, engagement of a traditional slotted type screwdriver only occurs at diagonally opposed engaging edges close to the terminal end of the tip, and therefore, most of the micro-grooves on the face are not actually involved in the engagement process, thereby providing minimal benefits.

Therefore when considering the above, applicant believes there is a valid need to improve upon the slotted type screwdriver and its engagement with a work-piece such as a screw, to reduce the potential of cam-out and disengagement under torque.

### SUMMARY OF THE INVENTION

In one embodiment, the present invention is an engaging portion of a screwdriver formed for engagement with a work-piece such as a screw. The engaging portion has an engaging tip, a front face, a rear face and opposing side walls. Each side wall has a front groove and a rear groove. Each groove has a wide region and a narrow region with the narrow region located closer to the tip than the wide region so as to create a torque-enhancing side wall edge.

Relative to the foregoing, applicant considers the following objectives.

It is an important objective of the present invention to improve the interaction and engagement between a slotted type screwdriver and slotted work-piece such as a screw etc., to reduce the potential of cam-out and disengagement under torque.

And, it is another important objective of the present invention that the strength and durability of the engaging portion of the screwdriver be equal to or greater than prior art versions.

And, it is yet another important objective of the present invention that the screwdriver be cost-efficient to manufacture and commercially viable.

### BRIEF DESCRIPTION OF THE DRAWINGS

FIG. 1 shows a front, cut view of the engaging portion of a prior art slotted type screwdriver; and,

FIG. 2 shows a right side, cut view of the prior art slotted type screwdriver shown in FIG. 1; and,

FIG. 3 shows a front, cut view of the engaging portion of another prior art slotted type screwdriver; and,

FIG. 4 shows a right side, cut view of the prior art slotted type screwdriver shown in FIG. 3; and,

FIG. 5 shows a front, cut view of the engaging portion of a present invention slotted type screwdriver; and,

FIG. 6 shows a right side, cut view of the present invention slotted type screwdriver shown in FIG. 5; and,

FIG. 7 shows a front, cut view of the engaging portion of another embodiment of the present invention slotted type screwdriver; and,

FIG. 8 shows a right side, cut view of the present invention slotted type screwdriver shown in FIG. 7; and,

FIG. 9 shows a front, cut view of the engaging portion of yet another embodiment of the present invention slotted type screwdriver; and,

FIG. 10 shows a right side, cut view of the present invention slotted type screwdriver shown in FIG. 9; and,

FIG. 11 shows a front, cut view of the engaging portion of yet another embodiment of the present invention slotted type screwdriver.

### DETAILED DESCRIPTION OF THE DRAWINGS

The various drawings provided herein are for the purpose of illustrating possible embodiments of the present invention and not for the purpose of limiting same. Therefore, the drawings herein represent only a few of the many possible embodiments, variations and/or applications of the present invention.

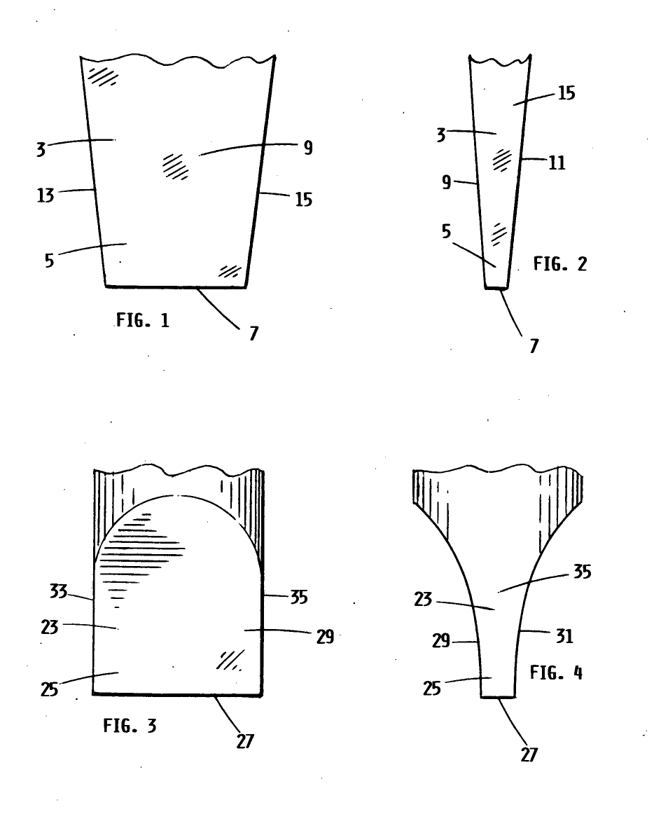

FIG. 1 shows a front, cut view of the engaging portion of a prior art slotted type screwdriver; and, FIG. 2 shows a right side, cut view of the prior art screwdriver shown in FIG. 1. Referring to FIGS. 1 and 2 together, screwdriver 3 has an engaging portion 5 formed for engagement with a work-piece such as a screw. Engaging portion 5 has an engaging tip 7, a front face 9, a rear face 11, and opposing side walls 13 and 15. Sidewall 15 is best seen in the right side view of FIG. 2. Side wall 15 and sidewall 13 are each relatively smooth and flat. The engaging portion of this typical, prior art slotted screwdriver has opposing faces and opposing sidewalls that diverge outwardly from the tip as shown to enhance strength. Accordingly, the opposing faces and opposing sidewalls form side wall edges that diverge outwardly from the tip. Such a structure tends to promote cam-out and disengagement with a work-piece such as a screw (not shown.)

FIG. 3 shows a front, cut view of the engaging portion of another prior art slotted type screwdriver; and, FIG. 4 shows a right side, cut view of the prior art screwdriver shown in FIG. 3. Referring to FIGS. 3 and 4 together, screwdriver 23 has an engaging portion 25 formed for engagement with a work-piece such as a screw. Engaging portion 25 has an engaging tip 27, a front face 29, a rear face 31, and opposing side walls 33 and 35. Sidewall 35 is best seen in the right side view of FIG. 4. Side wall 35 and sidewall 33 are each relatively smooth and convex as shown. The engaging portion of this typical, prior art slotted screwdriver has opposing faces that are relatively parallel to the other, and opposing sidewalls that are relatively parallel to the other as shown. Accordingly, the opposing faces and opposing sidewalls form side wall edges that are substantially parallel to each other and perpendicular to the tip. Such a structure does not inhibit cam-out and disengagement of the engaging portion with a work-piece such as a screw (not shown.)

FIG. 5 shows a front, cut view of the engaging portion of a present invention slotted type screwdriver; and, FIG. 6 shows a right side, cut view of the present invention screwdriver shown in FIG. 5. Referring to FIGS. 5 and 6 together, screwdriver 53 has an engaging portion 55 formed for engagement with a work-piece such as a screw. Engaging portion 55 has an engaging tip 57, a front face 59, a rear face 61, and opposing side walls 63 and 65. Sidewall 65 is best seen in the right side view of FIG. 6. Side wall 65 has a front groove 67 and a rear groove 69 as shown. Side wall 63 also has a front groove and rear groove with only the front groove 71 visible in FIG. 5. Each of the four grooves of the present invention has a wide region and a narrow region. For example, the front groove 67 of sidewall 65 has a narrow region 73 and a wide region 75 as shown. A characteristic of the present invention screwdriver is that the narrow region of each such groove is located closer to the tip than the wide region so as to create a torque-enhancing side wall edge. For example, narrow region 73 of groove 67 is located closer to the tip 57 than the wide region 75 so as to create a torque-enhancing side wall edge 77. Such a structure allows the opposing faces and opposing sidewalls to diverge outwardly for strength as shown, yet the side wall engagement edges (77 for example) diverge inwardly from the tip, at least for a short distance, creating a torque-enhancing engagement edge which reduces the tendency of cam-out and disengagement with a work piece such as a screw. A “groove” shall be defined herein as any elongated region or channel that is cut, machined, molded etc. And, a side wall edge of the present invention slotted type may be linear, arcuate, or any combination thereof, etc.

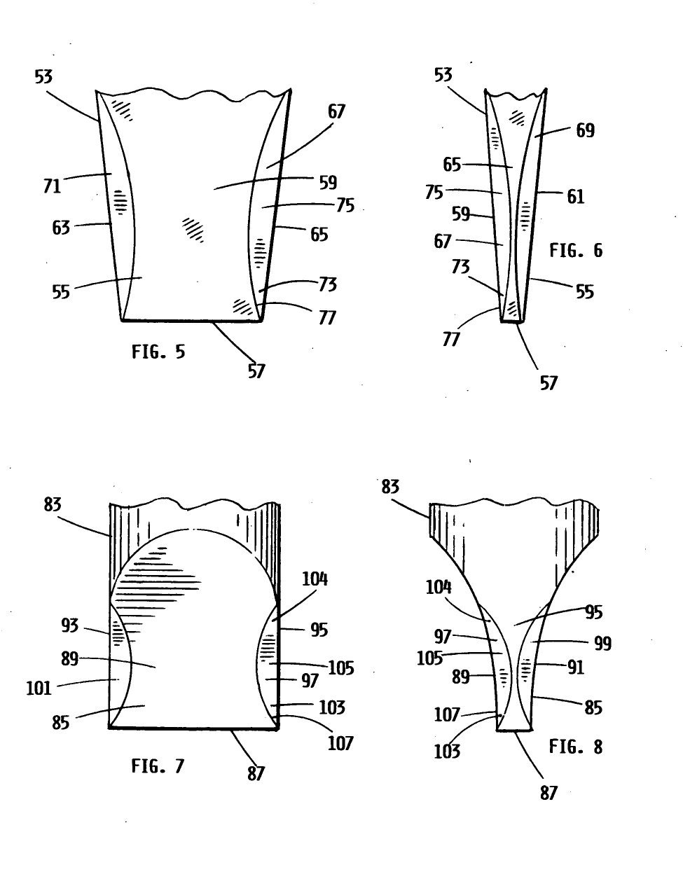

FIG. 7 shows a front, cut view of the engaging portion of another embodiment of the present invention slotted type screwdriver; and, FIG. 8 shows a right side, cut view of the present invention screwdriver shown in FIG. 7. Referring to FIGS. 7 and 8 together, screwdriver 83 has an engaging portion 85 formed for engagement with a work-piece such as a screw. Engaging portion 85 has an engaging tip 87, a front face 89, a rear face 91, and opposing side walls 93 and 95. Sidewall 95 is best seen in the right side view of FIG. 8. Side wall 95 has a front groove 97 and a rear groove 99 as shown. Side wall 93 also has a front groove and rear groove with the front groove 101 visible in FIG. 7. In this embodiment of the present invention shown, each groove has a wide region located between two narrow regions with one narrow region being located closer to the tip than a wide region so as to create a torque-enhancing side wall edge. For example the front groove 97 of sidewall 95 has two narrow regions 103 and 104, and a wide region 105 as shown. A characteristic of this embodiment of the present invention screwdriver is that a narrow region of each such groove is located closer to the tip than a wide region so as to create a torque-enhancing side wall edge. For example, narrow region 103 of groove 97 is located closer to the tip 87 than wide region 105 so as to create a torque-enhancing side wall edge 107. Such a structure allows the opposing faces and opposing sidewalls to be substantially parallel to each other as shown, yet the side wall engagement edges (107 for example) diverge inwardly from the tip, at least for a short distance, creating a torque-enhancing effect which reduces the tendency of cam-out and disengagement with a work piece such as a screw. Once again, a “groove” shall be defined herein as any elongated region or channel that is cut, machined, molded etc. A torque-enhancing side wall edge of the present invention may be linear, or arcuate, or any combination thereof, etc.

FIG. 9 shows a front, cut view of the engaging portion of yet another embodiment of the present invention slotted type screwdriver; and, FIG. 10 shows a right side, cut view of the present invention screwdriver shown in FIG. 9. Referring to FIGS. 9 and 10 together, screwdriver 153 has an engaging portion 155 formed for engagement with a work-piece such as a screw. Engaging portion 155 has an engaging tip 157, a front face 159, a rear face 161, and opposing side walls 163 and 165. Sidewall 165 is best seen in the right side view of FIG. 10. Side wall 165 has a front groove 167 and a rear groove 169 as shown. Side wall 163 also has a front groove and rear groove with the front groove 171 visible in FIG. 9. Each of the four grooves of the present invention has a wide region and a narrow region. For example the front groove 167 of sidewall 165 has a narrow region 173 and a wide region 175 as shown. A characteristic of the present invention screwdriver is that the narrow region of each such groove is located closer to the tip than the wide region so as to create a torque-enhancing side wall edge. For example, narrow region 173 of groove 167 is located closer to the tip 157 than the wide region 175 so as to create a torque-enhancing side wall edge 177. Such a structure allows the opposing faces and opposing sidewalls to diverge outwardly for strength as shown, yet the side wall engagement edges (177 for example) diverge inwardly from the tip, at least for a short distance, creating a torque-enhancing effect which reduces the tendency of cam-out and disengagement with a work piece such as a screw. Once again, a “groove” shall be defined herein as any elongated region or channel that is cut, machined, molded etc. A torque-enhancing side wall edge of the present invention may be linear, or arcuate, or any combination thereof, etc. In this embodiment, the grooves such as groove 167 for example, are each arcuate with a constant radius. In addition, small lateral grooves such as lateral groove 158 are placed on front face 159 (and the rear face 161 for that matter) to slightly increase the coefficient of friction between the engaging portion 155 of screwdriver 153 and the work-piece such as a screw not shown.

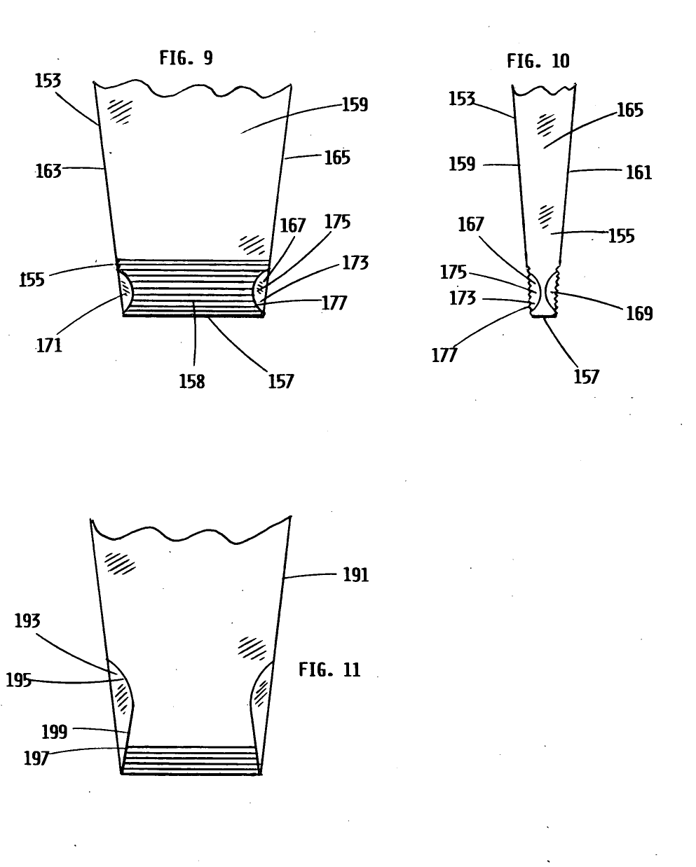

FIG. 11 shows a front, cut view of the engaging portion of yet another embodiment of the present invention slotted type screwdriver, wherein screwdriver 191 has groove 193, for example, creating a torque-enhancing edge 197 that comprises a linear portion 199 and arcuate portion 195.

Upon reading and understanding the specification of the present invention described above, modifications and alterations will become apparent to those skilled in the art. It is intended that all such modifications and alterations be included insofar as they come within the scope of the patent as claimed or the equivalence thereof.

Having thus described the invention, the following is claimed:

1. A screwdriver having an engaging portion formed for engagement with a work piece, the improvement which comprises:
said engaging portion having an engaging tip, a front face, a rear face and opposing side walls, each said side wall having a front groove and a rear groove, each of said grooves having a wide region and a narrow region with said narrow region being located closer to said tip than said wide region so as to create a torque-enhancing side wall edge.

2. The screwdriver of claim 1 wherein the front groove and the rear groove of at least one of said side walls have linear edges.

3. The screwdriver of claim 1 wherein the front groove and the rear groove of at least one of said side walls have arcuate edges.

4. The screwdriver of claim 1 wherein the front groove and the rear groove of each of said side walls have linear edges.

5. The screwdriver of claim 1 wherein the front groove and the rear groove of each of said side walls have arcuate edges.

6. The screwdriver of claim 1 wherein the front groove of one of said side walls has linear edges and the rear groove of another of said side walls has linear edges.

7. The screwdriver of claim 1 wherein the front groove of one of said side walls has arcuate edges and the rear groove of another of said side walls has arcuate edges.

8. The screwdriver of claim 1 wherein the opposing side walls are substantially parallel to each other as viewed from a front view thereof.

9. The screwdriver of claim 1 wherein the opposing side walls taper outwardly with increasing distance from said engaging tip as viewed from a front view thereof.

10. The screwdriver of claim 8 wherein each of said grooves forms a side wall edge that is arcuate with a constant radius.

11. The screwdriver of claim 9 wherein each of said grooves forms a side wall edge that is arcuate with a constant radius.

12. A screwdriver having an engaging portion formed for engagement with a work piece, the improvement which comprises:
said engaging portion having an engaging tip, a front face, a rear face and opposing side walls, each said side wall having a front groove and a rear groove, each of said grooves having a wide region located between two narrow regions with one said narrow region being located closer to said tip than said wide region so as to create a torque-enhancing side wall edge.

13. The screwdriver of claim 12 wherein the front groove and the rear groove of at least one of said side walls have linear edges.

14. The screwdriver of claim 12 wherein the front groove and the rear groove of at least one of said side walls have arcuate edges.

15. The screwdriver of claim 12 wherein the front groove and the rear groove of each of said side walls have linear edges.

16. The screwdriver of claim 12 wherein the front groove and the rear groove of each of said side walls have arcuate edges.

17. The screwdriver of claim 12 wherein the front groove of one of said side walls has linear edges and the rear groove of another of said side walls has linear edges.

18. The screwdriver of claim 12 wherein the front groove of one of said side walls has arcuate edges and the rear groove of another of said side walls has arcuate edges.

19. The screwdriver of claim 12 wherein the opposing side walls are substantially parallel to each other as viewed from a front view thereof.

20. The screwdriver of claim 12 wherein the opposing side walls taper outwardly with increasing distance from said engaging tip as viewed from a front view thereof.

21. The screwdriver of claim 19 wherein each of said grooves forms a side wall edge that is arcuate with a constant radius.

22. The screwdriver of claim 20 wherein each of said grooves forms a side wall edge that is arcuate with a constant radius.
